(19) United States
(12) Patent Application Publication
(10) Pub. No.: US 2005/0223909 A1
(43) Pub. Date: Oct. 13, 2005

(54) Method for purifying cooking oil and cooking oil filter apparatus

(76) Inventor: Katsuhiko Kurata, Tokyo (JP)

Correspondence Address: RABIN & Berdo, PC, 1101 14TH STREET, NW, SUITE 500, WASHINGTON, DC, 20005, US

(21) Appl. No.: 11/090,307

(22) Filed: Mar. 28, 2005

(30) Foreign Application Priority Data
Mar. 30, 2004 (JP) 2004-100808

(51) Int. Cl. A47J 37/12

(52) U.S. Cl. 99/408

(57) ABSTRACT

To use cooking oil repeatedly for a long time while maintaining quality of the cooking oil in a good condition, a cooking oil filter apparatus according to this invention filters the cooking oil collected from a fryer in using a filtering material. A fragment of granite porphyry containing amphibole is used as the filtering material. The granite porphyry containing the amphibole indicates a good antioxidant effect against the cooking oil, and the cooking oil is recycled upon contact with the granite porphyry, thereby prevented from degrading. As a structure, for example, the apparatus has a filter cartridge containing the fragment of the granite porphyry containing the amphibole, in which a basket and a paper filter respectively in a mesh form are disposed on the filter cartridge.

### BACKGROUND OF INVENTION

1. Field of the Invention

This invention relates to a method for purifying cooking oil and a cooking oil filter apparatus for circularly purifying cooking oil.

2. Description of Related Art

Cooking oil in a large amount is used everyday for cooking fried food such as, e.g., Tempura as Japanese traditional fried food, fried chickens, or the like, in kitchens of restaurants, delicatessens, etc. However, when used longer, the cooking oil becomes oxidized to give off odor, peroxide, or the like, thereby becoming inedible. It may happen that a number of volatile components generated from the degraded cooking oil may come to fill the kitchen to harmfully affect physical conditions of workers. Although causing various troubles as described above, such a degraded cooking brings uneconomical state and becomes a source of environmental pollutions to discard the cooking oil after every cooking because of the oil in a large amount. Therefore, a filter apparatus for the cooking oil is generally placed near a fryer for cooking fried foods so the used cooking oil is filtered and used repeatedly.

Cooking oil filter apparatuses generally have a structure in which a filter device for filtering effectively extraneous substances in various sizes (e.g., dregs of fried food), or the like, is installed in a multistage manner to an inside of an oil tank for storing the cooking oil collected from the fryer, and a pump returns the cooking oil filtered with the filter device to the fryer. Various filter apparatuses of such type have been conventionally proposed, and for example, a cooking oil filter apparatus for commercial use, installed with a cartridge filled with sepiolite serving as a filtering material has been widely known (see, e.g., Japanese Patent Application Publication (Laid open) No. JA-H11-35,970). This apparatus is supposed to enable the filtering material to be reduced without degrading recycling capacity of the cooking oil.

However, the above described art is such that the sepiolite (a hydrated magnesium silicate mineral) is used as the filtering material, and that use of natural stone or minerals of other kinds is not described at all. Furthermore, the above described art is not necessarily sufficient in terms of, e.g., duration of the recycling capacity, a purifying function for the cooking oil.

This invention is proposed in the light of the conventional situation as described above, and intended to provide a method for purifying cooking oil as well as a cooking oil filter apparatus capable of using the cooking oil repeatedly while maintaining quality of the cooking oil in a good condition.

### SUMMARY OF THE INVENTION

To solve the above described problems, a method for purifying cooking oil according to this invention is characterized in filtering the used cooking oil with use of a filtering material containing fragments of granite porphyry containing amphibole. A cooking oil filter apparatus according to this invention, for filtering the cooking oil collected from a fryer with use of the filtering material, is characterized in use of the filtering material containing the fragments of the granite porphyry containing the amphibole.

As a result of researches and analyses for a suitable filtering material for the cooking oil, conducted by the inventor, the granite porphyry containing the amphibole was turned out to be greatly suitable. Since the granite porphyry, especially the amphibole contained in the granite porphyry, indicates an antioxidant effect on the cooking oil, the cooking oil can be recycled and prevented from degrading upon rendering the granite porphyry containing the amphibole in contact with the cooking oil.

With the method for purifying the cooking oil and the cooking oil filter apparatus according to this invention, since the granite porphyry containing the amphibole is used as the filtering material, the cooking oil can be prevented from degrading and used repeatedly for a long time, so that time for exchanging the cooking oil can be prolonged to cut down the amount of discarded oil sharply. According to this invention, therefore, contribution for the environmental protection can be aimed while the cost for the cooking oil can be cut down. Furthermore, according to this invention, quality of the cooking oil can be maintained in a good condition upon suppressing occurrences of peroxide in the cooking oil, so that taste and flavor of cooked food can be improved.

### BRIEF DESCRIPTION OF THE DRAWINGS

This invention may take physical form in certain parts and arrangements of parts, a preferred embodiment and method of which will be described in detail in this specification and illustrated in the accompanying drawings which form a part hereof, and wherein;

FIG. 1 is an exploded perspective view showing an example of a cooking oil filter apparatus with application of this invention;

FIG. 2 is a schematic structure view for illustrating a method for filtering cooking oil with use of the cooking oil filter apparatus with application of this invention;

FIG. 3 is a characteristic graph showing time-variation of a peroxide value depending on existence or nonexistence of amphibole;

FIG. 4 is a characteristic graph showing time-variation of a carbonyl value depending on existence or nonexistence of amphibole; and

FIG. 5 is a characteristic graph showing time-variation of an acid value depending on existence or nonexistence of amphibole.

### DETAILED DESCRIPTION OF PREFERRED EMBODIMENTS OF THE INVENTION

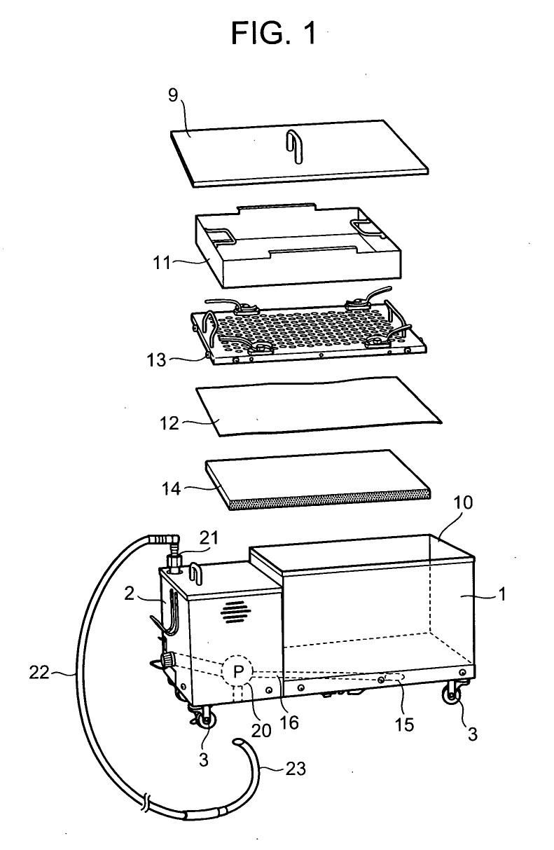

Hereinafter, a cooking oil filter apparatus according to this invention will be described in reference to drawings. The cooking oil filter apparatus with application of this invention has, as shown in FIG. 1, an oil tank 1 for containing the cooking oil used at a fryer and a machine chamber 2 for containing, e.g., a pump, a motor, etc. while being easily rendered movable upon installation of casters.

On an upper portion of the oil tank 1 for storing the cooking oil collected from the fryer, a basket 11 made of stainless steel or the like in a mesh form shaped in a box shape is equipped. The basket 11 catches extraneous substances of a comparatively large size, such as, e.g., dregs of fried food, upon filtering the used cooking oil, thereby preventing clogging on a paper filter 12 and on a filter cartridge 14 at subsequent stages. The dregs of the fried food, or the like caught with the basket 11 are to be cleaned up by time of next use.

The paper filter 12 as one type of filtering material is held with a filter holding member 13, thereby being fastened onto a predetermined position on a lower level of the oil tank 1. The paper filter 12 has smaller holes in a large number compared with the basket 11, thereby being able to collect the minute dregs of the fried food causing degradation on the cooking oil. Furthermore, the paper filter 12 has an advantage in terms of extremely easy handling since the paper filter 12 needs only to be replaced by new one after every use without taking a trouble such as, e.g., washing or the like. Regular paper made filters used for the cooking oil filter apparatus of this type can be used as the paper filter 12. The filter holding member 13 is made of stainless steel subjecting to a punching treatment and installed to a predetermined position inside the oil tank 1 to fasten the paper filter 12.

The filter cartridge 14 in which, e.g., the filtering material is contained in a box in a flat plate form, made of a mesh of stainless steel, is mounted on a bottom surface of the oil tank 1, at a further lower level compared with the paper filter 12.

In this invention, the granite porphyry containing the amphibole, grinded in an appropriate size, is used as the filtering material. Above all, the granite porphyry mined at Touno city in Iwate prefecture in Japan contains, unlike the general granite porphyry mined at other areas, various mineral, especially the amphibole, and furthermore titanium oxide as a component, thereby exerting extremely useful effects as the filtering material for the cooking oil.

The granite porphyry containing the amphibole, mined at Touno city in Iwate prefecture in Japan, suppresses oxidation of oils and fats upon absorbing the extremely minute substances (e.g., a transition metal ion such as, e.g., a copper ion or the like) in the cooking oil. That is, this granite porphyry containing the amphibole indicates an antioxidant effect. Furthermore, since indicating an odor eliminating effect, the granite porphyry containing the amphibole, mined at Touno city in Iwate prefecture in Japan, can suppress generation of odor upon contact with the cooking oil. Furthermore, since having extremely high far-infrared emissivity, the granite porphyry containing the amphibole, mined at Touno city in Iwate prefecture in Japan, has an advantage such that upon putting this granite porphyry containing the amphibole in the fryer, the food can be fried at a low temperature and cooked up crisply without getting grease.

The granite porphyry containing the amphibole may be broken into fragments of an appropriate size and directly used as the filtering material, or may be used after changed into ceramic upon mixed with clay. Furthermore, the above fragments and the above ceramic may be mixed and used.

As a result of an X-ray diffraction analysis on the granite porphyry mined at Touno city in Iwate prefecture in Japan, used in this invention, quartz, alibite, anorthite, chamosite, etc. were detected other than the amphibole. As a result of a quantitative analysis on the granite porphyry mined at Touno city in Iwate prefecture in Japan, used in this invention, measured was silicon oxide of 60.27 percent, aluminum oxide of 17.02 percent, ferric oxide of 6.70 percent, titanium oxide of 0.72 percent, calcium oxide of 6.23 percent, magnesium oxide of 2.68 percent, sodium oxide of 3.26 percent, potassium oxide of 1.16 percent, and ignition loss of 1.15 percent. Accordingly, toxic substances such as cadmium, lead, mercury, and arsenic were not detected. The above analysis was carried out in accordance with a method established by “Standards for Foods and Additives” based on Article 10 and “Apparatus and Container/Package” based on Chapter 3 of Food Sanitation Law in Japan.

The granite porphyry mined at Touno city in Iwate prefecture in Japan, has a specific property such as indicating much higher value in a field of a measurement on weak magnetic energy (i.e., a wave motion), compared with rock or the like of other types. It is supposed that the wave motion is magnetism of a longitudinal wave (a wave of condensation and rarefaction or a compression wave) moving in the same direction as an electric current while the magnetism of the longitudinal wave is energy resonantly released by electric particles supporting electron movement. The weak magnetic energy derived from the wave motion can be measured with an Ultra Sensitive Integration Vibration Analyzer. A quantum resonans spectrometer (QRS) disclosed in Japanese Patent Application Publication No. JA-2000-55,881 is especially suitable for measurement. Measurement results of the weak magnetic energy on the above described granite porphyry and each type of minerals are shown in Table 1. On the material used as the above filtering material, a measured value (immunity function) of the weak magnetic energy is preferably of not less than 48,000, and more preferably of not less than 1000,000. As apparent from Table 1, the weak magnetic energy of the above described granite porphyry is of not less than 200,000.

TABLE 1

| | Measurement |
|---|---|
| Analyte Name | Result |
| granite porphyry at Touno city in Iwate | 298,000 |
| prefecture in Japan | |
| Water purified with granite porphyry at | 262,000 |
| Touno city in Iwate prefecture in Japan | |
| hot spring water | 51,700 |
| sand (coral) | 51,000 |
| amethyst (in Brazil) | 28,200 |
| crystal (in Brazil) | 20,700 |
| tourmaline (in Brazil) | 15,900 |
| Bincho charcoal | 15,000 |
| Bakuhan stone (quartz porphyry) | 9,900 |
| filtering sand for water supply | 5,600 |
| river sand | 15 |
| tap water (in Tokyo prefecture in Japan) | 1 |

With the cooking oil filter apparatus according to this invention, the paper filter 12 and the filter cartridge 14 can be taken out of an inside of the oil tank 1 upon unlocking the filter holding member 13, and can be easily replaced depending on degradation degree.

An oil outlet is formed on the bottom portion of the oil tank 1, in which the cooking oil inside the oil tank 1 is drained, upon opening a valve, to a pipe 16 connected to the oil outlet 15. The other end of the pipe 16 connected to the oil outlet 15 is coupled to a pump 20 inside the machine chamber 2.

The machine chamber 2 has inside the pump 20 for pumping up the filtered cooking oil drained from the oil outlet 15 in the oil tank 1. A discharge side of the pump 20 is connected through the pipe to a discharge opening 21 arranged to a side surface of the machine chamber 2. A base portion of a hose 22 having a prescribed length is installed in a detachably attachable manner to the discharge opening 21. A nozzle 23 curved in a substantially letter U form, having a front end for expelling the cooking oil transmitted from the pump 20, is installed to a front end of the hose 22.

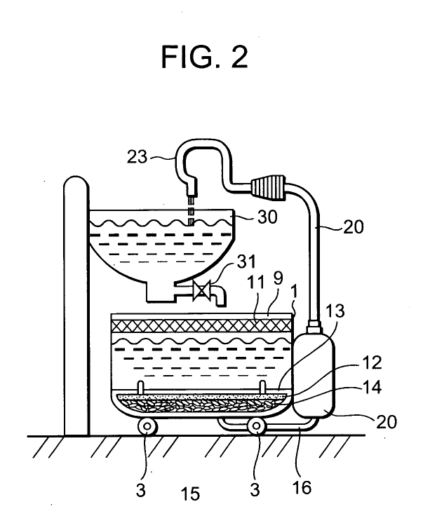

A filtering operation with use of the cooking oil filter apparatus thus structured is implemented as follows. First, a top cover 9 is detached to set the filter cartridge 14, the paper filter 12, the filter holding member 13, and the basket 11 to prescribed positions of the oil tank 1. As shown in FIG. 2, the cooking oil filter apparatus is moved under the fryer 30 while the nozzle 23 is placed above the fryer 30. Next, when opening the valve 31 disposed at the bottom portion of the fryer 30, the cooking oil inside the fryer 30 is flowed into the basket 11, and after the extraneous substances such as, e.g., the dregs of the fried food of a comparatively large size are caught with the basket 11, the cooking oil is stored inside the oil tank 1. When activating the pump 20, the cooking oil is filtered with the paper filter 12 and subsequently rendered in contact with the granite porphyry containing the amphibole serving as the filtering member inside the filter cartridge 14, thereby being filtered, so that the minute dregs of the fried food, minute metal, etc. inside the cooking oil are caught. The filtered cooking oil is pumped up with the pump 20, in order of the oil tank 1, the oil outlet 15, the pipe 16, the pump 20, the discharge opening 21, and the hose 22, thereby being returned from the nozzle 23 to the fryer 30. As described above, the dregs of the fried food, the minute metal, etc. as a cause for the degradation on the cooking oil, can be removed without discharging the cooking oil into a sewerage.

With the cooking oil filter apparatus of this type, the antioxidant effect of the granite porphyry containing the amphibole used as the filtering material, suppresses progress of the oxidation on the cooking oil, thereby being able to maintain high quality of the cooking oil. The cooking oil can be suppressed from degrading and giving off odor, thereby being able to provide the tasty and healthy cooked food. Furthermore, the cooking oil can be easily recycled upon circulated between the fryer and the cooking oil filter apparatus, without discharged into the sewerage.

Herein, the antioxidant effect of the amphibole contained in the granite porphyry, against the cooking oil, is described in reference to results of the experiment for measuring an acid value, a peroxide value, and a carbonyl value.

As samples of the cooking oil, oil on the market was prepared, such as salad oil (manufactured by The Nisshin Oillio Group, Ltd.), sesame oil (manufactured by Kodoya Sesame Mills Inc.), and corn oil (manufactured by Ajinomoto Co., Ltd.) On the basis that three test tubes respectively added with above three kinds of oil of 5 g were supposed as one set, five sets in which the natural amphibole of 0.5 g was added into each test tube and five sets in which nothing was added into each test tube were prepared, and thereafter heated in an oil bath of 180 degrees Celsius respectively for 0 hour, 12 hours, 24 hours, 48 hours, and 72 hours. Each of the cooled samples was put to the below described experiment for measuring the oxide value, the peroxide value, and the carbonyl value. In this situation, it is to be noted that the natural ARS amphibole broken into an uniform size of 5 to 10 mm was used to reveal the antioxidant effect of the amphibole contained in the granite porphyry, against the cooking oil.

(Peroxide Value Measurement)

The sample of 1 g was put into a stoppered conical flask, in which acetic acid: chloroform mixture (volume ratio of 3:2) of 25 milliliters was added thereto, and if necessary, heated generally to melt. After air inside the flask was once replaced with nitrogen gas, 1 milliliter of saturated solution of potassium iodide was added thereto, and the stoppered conical flask was immediately stoppered, shaken as mixed slowly, and left for 10 minutes. After added with water of 30 milliliters and shaken hard, the mixture inside the stoppered conical flask was added with starch solution of 1 milliliter as an indicator, thereby titrated with 0.01 N sodium sulfate solution. The measured values were corrected based on a blank experiment carried out independently. Results are shown in Table 3. In the drawings described hereinafter, it is to be noted that a black square indicates the sample added with the amphibole while a white square indicates the sample not added with the amphibole.

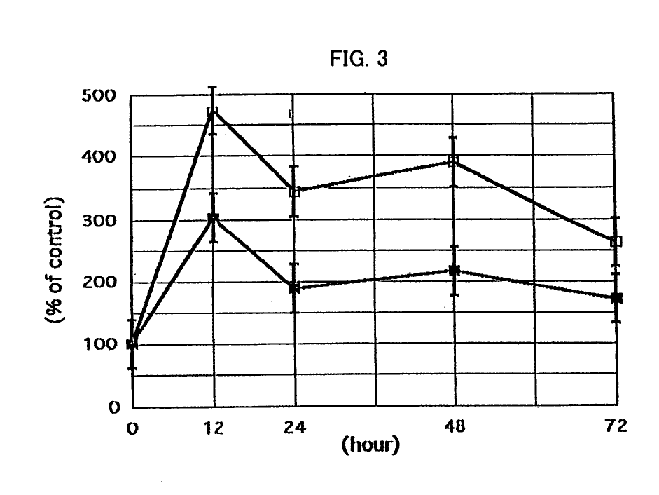

As shown in FIG. 3, the peroxide value was notably suppressed from increasing upon adding the amphibole to the heated fats and oils. Since the peroxide value is defined as a value indicating a proportion of double bond oxidation (peroxide amount) in the fats and oils, it is turned out that a suppressive effect against the double bond oxidation can be obtained upon adding the amphibole.

(Carbonyl Value Measurement)

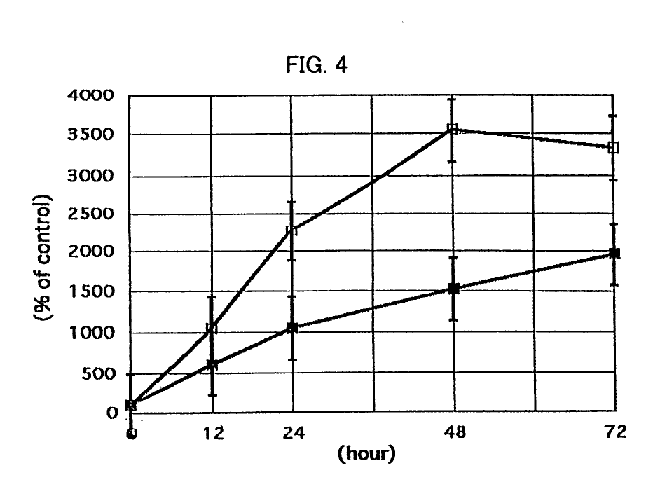

After the sample of 10 to 100 mg was put into a 50 ml measuring flask, added with benzene of 10 milliliter, and melted, 4 ml of benzene solution containing 4 percent trichloroacetic acid and 5 ml of benzene solution containing 0.05 percent 2, 4-dinitrophenylhydrazine were added thereto, and the measuring flask was thereafter loosely stoppered and heated in a water bath of 60 degrees Celsius for 30 minutes. After left and cooled down, the mixture was colored upon adding 10 ml of ethanol solution containing 4 percent potassium hydroxide, and thereafter measured to 50 ml with ethanol. After the mixture was left for 30 minutes, absorbance at 440 nm was measured. The carbonyl value is indicated with the absorbance per gram while corrected based on a blank experiment. Results are shown in FIG. 4.

As shown in FIG. 4, the carbonyl value was notably suppressed from increasing upon adding the amphibole to the heated fats and oils. Since the carbonyl value indicates a proportion of alcohol oxidation (aldehyde formation) caused due to double bond oxidation in the fats and oils while being defined as a typical character of degradation on the fats and oils, it was turned out that the amphibole has a preventive effect against the oxidation in the fats and oils, including the alcohol oxidation.

(Oxide Value Measurement)

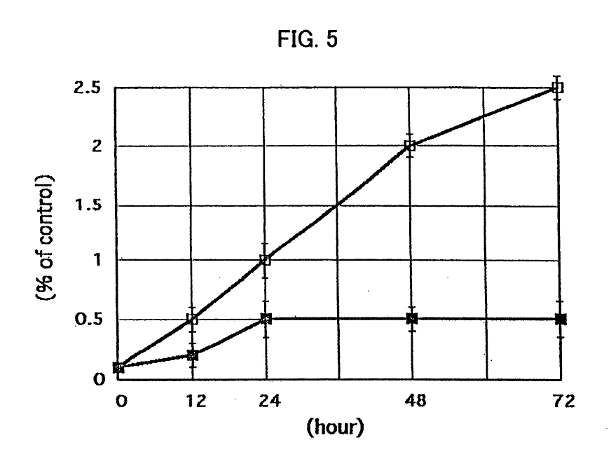

The sample of 2.5 g was melted into neutral ether:ethanol solution (1:1) of 100 ml, and added with ethanol solution containing 1 percent phenolphthalein, and thereafter titrated with 0.01 N sodium ethanol solution until a damask color was maintained for 30 seconds. In this situation, it is to be noted that where turbidity occurred during titration, the ether:ethanol solution (1:1) was further added to dissolve. Results were shown in FIG. 5.

As shown in FIG. 5, the oxide value could be suppressed from increasing as well upon adding the amphibole. Since the oxide value indicates the amount of free fatty acid (i.e., rancidity) due to hydrolysis or oxidation, it was turned out that the amphibole could suppress the oil from turning rancid.

It is generally supposed that the oxidation in the fats and oils is started with active oxygen such as, e.g., singlet molecular oxygen in an exited state (¹O₂—.), superoxide radical (O₂—.), hydrogen peroxide (H₂O₂), hydroxy radical (OH), etc., however, as indicated with Formula 1, the amphibole used in this invention is supposed to suppress the oxidation in the fats and oils upon trapping peroxide radical (ROO.) and hydroperoxide (ROOH).
Lipid→ROO→ROOH→ROH Formula 1

As indicated with below Formulas 2, 3, such a reaction is highly possible as formation mechanism for the active oxygen, that O₂— reduces transition metal ion (Mⁿ⁺) to M⁽ⁿ⁻¹⁾⁺, and M⁽ⁿ⁻¹⁾⁺ reduces H₂O₂ generated upon a dismutation reaction to OH—.

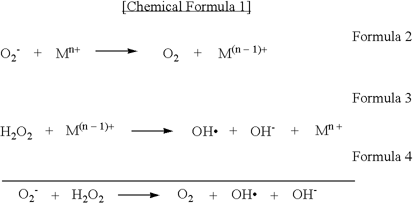

In the meantime, it is supposed the amphibole forms and eliminates the active oxygen since H₂O₂ is suppressed from forming upon a reaction between O₂— and the transition metal (Mⁿ⁺) such as, e.g., copper, manganese, iron, etc. as indicated with below Formula 5, or since H₂O₂ formed upon excessive existence of O₂— as indicated with Formulas 6, 7, is trapped in a way of a scavenger method as indicated with Formula 8 or eliminated in a way of a peroxidase method.

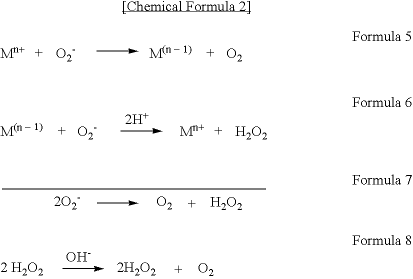

It was actually ascertained in experiments that where the amphibole is dropped in the cooking oil heated at 180 degrees Celsius for seventy two hours, a content of calcium, copper, and magnesium lowers notably compared with a case where the amphibole is not dropped, that is, the copper ions having a formation enhancing effect for the active oxygen decrease.

It is therefore supposed that the amphibole has the antioxidant effect mainly because the amphibole absorbs the metal ions such as, e.g., the copper ion (Cu²+) or the like, to suppress a progress of the reaction such as indicated with Formulas 9, 10, 11, while on the other hand, as indicated with Formula 8, Mg²⁺ or Ca²⁺ in the cooking oil catalytically enhances the dismutation reaction of H₂O₂ to eliminate partially remaining H₂O₂ in a stage of Formula 11.

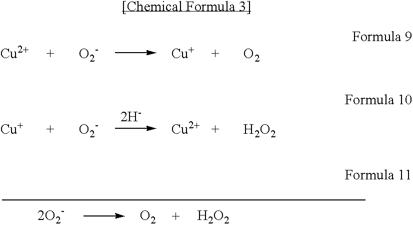

Based on the above experimental results, it is supposed that the antioxidant effect of the amphibole enables the cooking oil filter apparatus according to this invention, with use of the granite porphyry containing the amphibole, to have the suppression effect against the degradation on the cooking oil.

Furthermore, a quality value of each cooking oil of various types was evaluated upon filtering, with use of the cooking oil filter apparatus of this invention, the cooking oil used for cooking in the actual kitchen.

Such operation was implemented that the food was fried with the fryer during business hours, and then the used cooking oil was filtered and returned again to the fryer after the business hours, with use of the cooking filter apparatus having the filter cartridge containing the filtering material, i.e., fragments of the granite porphyry mined at Touno city in Iwate prefecture in Japan. With respect to the cooking oil after a repeat of the above operation for 10 days, moisture, foreign substances, unsaponifiable substances, an acid value, a peroxide value, and chromatism, were measured. As a result, the moisture of 0.04 percent, the foreign substance of less than or equal to 0.01 percent, the unsaponifiable substance of 0.68 percent, the acid value of 2.90 percent, and the peroxide value of 1.00 meq/kg were measured by the Karl Fischer method while yellow of 40.0 and red of 4.3 were measured by the Lovibond method using 1 cm cell. These values are regarded as high considering the cooking oil was already repeatedly used for 10 days, and it was therefore confirmed that the quality of the cooking oil can be maintained in a good condition for a long time upon using the cooking oil filter apparatus according to this invention.

On the other hand, where the same operation was implemented with using the cooking oil filter apparatus of the conventional type, in which a voltage is applied to a net, with respect to the cooking oil after used for 10 days, the moisture of 0.21 percent, the foreign substance of 0.46 percent, the unsaponifiable substance of 0.87 percent, the acid value of 3.09 percent, and the peroxide value of 0.90 meq/kg were measured by the Karl Fischer method while yellow of 45.0 and red of 4.7 were measured by the Lovibond method using 1 cm cell. Notable differences were confirmed especially on the moisture and the foreign substance, so that the conventional apparatus was turned out not to have a sufficient function for maintaining the quality of the cooking oil.

With cooperation of a supermarket, a quality maintenance capacity against the cooking oil used under a more rough condition was examined. With the fryer at the supermarket, the cooking oil is recycled in order, e.g., in order of Tempura, croquettes, and fried chicken, and dumped very often after used for the fried chicken in the last stage. Thus, the quality maintenance capacity against the cooking oil used for the fried chicken was inspected. The used fryer consists of a Tempura tank, croquette tanks A, B, and fried chicken tanks A, B, and the cooking oil get degraded more severely in this order. The fried chicken tank B is supposed as the most rough condition.

In the experiment, the cooking oil in the fried chicken tanks A, B, was inspected with regard to chromaticity, oxidation, and viscosity rise. Results are shown in Table 2.

TABLE 2

| | | chromaticity (133.4 mm) | | | | | viscosity | |
|---|---|---|---|---|---|---|---|---|
| | | | | | red × 10 + yellow | | (25 degrees | rise |
| | | red | yellow | blue | + blue × 20 | oxidation | C,cSt) | rate (%) |
| new oil | | 0.7 | 3.8 | 0 | 10.8 | 0.05 | 62.5 | — |
| without filter | A | 20.4 | 33 | 6.2 | 361 | 2.25 | 68.5 | 9.6 |
| apparatus | B | 20.4 | 33 | 8.2 | 401 | 3.25 | 70.8 | 13.3 |
| (7 days) | | | | | | | | |
| with filter | A | 22.7 | 25 | 3.6 | 324 | 1.66 | 67.9 | 8.6 |
| apparatus | B | 21.5 | 25 | 7.2 | 381 | 2.69 | 69.6 | 11.4 |
| (7 days) | | | | | | | | |
| with filter | A | 25.2 | 36 | 6.3 | 414 | 2.54 | 68.1 | 9 |
| apparatus | B | 20.4 | 36 | 10.3 | 446 | 4.70 | 69.9 | 11.8 |
| (10 days) | | | | | | | | |

It is turned out that where the cooking oil filter apparatus according to this invention is used, all of the chromaticity, the oxidation, and the viscosity rise are smaller compared with a case of nonuse of the filter apparatus. The result was obtained, in which the cooking oil used for 7 days, without the filter apparatus, is hardly different from the cooking oil used for 10 days, with the cooking oil filter apparatus according to this invention, so that the filter apparatus according to this invention was demonstrated to have an effect for the long-term quality maintenance.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention should not be limited by the specification, but be defined by the claims set forth below.

1. A method for purifying cooking oil, comprising the steps of:
preparing a filtering material containing a fragment of granite porphyry containing amphibole; and
filtering used cooking oil in using the filtering material.

2. The method for purifying the cooking oil according to claim 1, wherein the granite porphyry containing the amphibole has weak magnetic energy not less than 48,000.

3. The method for purifying the cooking oil according to claim 2, wherein the weak magnetic energy is not less than 100,000.

4. The method for purifying the cooking oil according to claim 1, wherein the granite porphyry containing the amphibole contains titanium oxide.

5. A cooking oil filter apparatus for filtering cooking oil comprising:
a collecting device for collecting the cooking oil from a fryer; and
a filtering material attached to the collecting device, said filtering material containing a fragment of granite porphyry containing amphibole.

6. The cooking oil filter apparatus according to claim 5, wherein the granite porphyry containing the amphibole has weak magnetic energy not less than 48,000.

7. The cooking oil filter apparatus according to claim 6, wherein the weak magnetic energy is not less than 100,000.

8. The cooking oil filter apparatus according to claim 5, wherein the granite porphyry containing the amphibole contains titanium oxide.

9. The cooking oil filter apparatus according to claim 5, wherein the filtering material is made of a ceramic containing the fragment of the granite porphyry containing the amphibole.

10. The cooking oil filter apparatus according to claim 9, wherein the filtering material made of the ceramic is in a grained form or in a ball form.

11. The cooking oil filter apparatus according to claim 5, wherein the collecting device is formed with a filter cartridge to which the filtering material is attached.

12. The cooking oil filter apparatus according to claim 11, wherein the filter cartridge has a basket and a paper filer respectively in a mesh form disposed on the cartridge.
